(19) United States
(12) Patent Application Publication
(10) Pub. No.: US 2026/0278378 A1
(43) Pub. Date: Sep. 17, 2026

(54) SYSTEMS AND METHODS FOR COMPRESSED DATA OFFLOADING FOR LLM INFERENCE

(71) Applicants: Advanced Micro Devices, Inc., Santa Clara, CA (US); ATI Technologies ULC, Markham (CA)

(72) Inventors: Mehdi Saeedi, Thornhill (CA); Gabor Sines, Toronto (CA); Arun Coimbatore Ramachandran, Bangalore (IN); Arjun Muraleedharan, Bengaluru (IN); Ganesh Prasad Nagaraja, Bangalore (IN); Samantray Biplab Raut, Bangalore (IN); Ian Charles Colbert, San Diego, CA (US)

(21) Appl. No.: 19/076,665

(22) Filed: Mar. 11, 2025

(51) Int. Cl. G06N 3/082; G06N 3/0495

(52) U.S. Cl. CPC G06N 3/082; G06N 3/0495

(57) ABSTRACT

An apparatus and method for efficiently performing efficient data storage and data transfer of machine learning (ML) data. In various implementations, a host processing circuit of a computing system executes an ML application. The application includes a computational graph that provides the computational order of the ML nodes, layers and stages of the ML model. The host processing circuit translates function calls in the application to commands particular to an accelerator circuit. When data storage capacity of the local memory of the accelerator circuit exceeds a threshold, the accelerator circuit compress one or more of the weights and intermediate data prior to offloading this data from the local memory based on completion of execution of a corresponding ML layer and a compression ratio being greater than a ratio based on decompression throughput and data transfer rates between levels of a memory hierarchy.

### BACKGROUND

### Description of the Relevant Art

The parallelization of tasks is used to increase the throughput of computing systems. To this end, compilers extract parallelized tasks from applications to execute in parallel on the computing system hardware. Parallel data processing circuits execute multiple threads simultaneously in order to take advantage of the identified instruction-level parallelism. The performance of computing systems increases with the scheduling of parallel data tasks on parallel data processing circuits. One or more of these parallel data processing circuits can support a machine learning (ML) model. The ML model uses machine learning techniques that rely on one of a variety of types of neural network structures. The ML model uses one or more layers of nodes to generate an output value representing a prediction when given a set of input data values.

With the addition of one or more parallel data processing circuits, the computing system hardware supports the data computing requirements of executing the instructions of the ML model. However, the computing system hardware also needs to support the data storage requirements and the memory bandwidth requirements of the ML model. The parameters of the ML model include at least the input data values, the weight values, the activation function bias values, and the activation values such as activation tensors. In some designs, a representative number of the relatively high number of these parameters used by the ML model can range from tens of billions of parameters to hundreds of billions of parameters. In some designs, a representative amount of data storage of these parameters in one memory can range from hundreds of gigabytes to a few terabytes with data transfer rates reaching hundreds of gigabytes per second.

The computing system typically includes second memory such as an off-chip hard disk drive or solid-state drive. Examples of the user's computing device that includes the computing system are a desktop computer, a laptop computer, a tablet computer, a smartphone, a smartwatch and so forth. Even if the secondary memory can support the above data storage requirement, the other levels of the memory hierarchy located closer to the one or more parallel processing circuits typically can't provide the data storage requirement and data transfer rates for supporting execution of the ML model. Therefore, the performance suffers, or the computing device is unable to execute applications relying on the ML model.

In view of the above, methods and apparatuses for efficient support of machine learning model data storage requirements and data transfer rates requirements are desired.

### BRIEF DESCRIPTION OF THE DRAWINGS

FIG. 1 is a generalized diagram of a sequence diagram in a computing system that performs efficient data storage and data transfer of machine learning data.

FIG. 2 is a generalized diagram of a machine learning model that performs efficient data storage and data transfer of machine learning data.

FIG. 3 is a generalized diagram of a machine learning initial attention stage that performs efficient data storage and data transfer of machine learning data.

FIG. 4 is a generalized diagram of an attention layer of a machine learning model.

FIG. 5 is a generalized diagram of encoder and decoder block components of a machine learning model.

FIG. 6 is a generalized diagram of processing stages of a transformer of a machine learning model.

FIG. 7 is a generalized diagram of a computational graph of a machine learning model.

FIG. 8 is a generalized diagram of a method for performing efficient data storage and data transfer of machine learning data.

FIG. 9 is a generalized diagram of a computing system that performs efficient data storage and data transfer of machine learning data.

FIG. 10 is a generalized diagram of an apparatus that performs efficient data storage and data transfer of machine learning data.

FIG. 11 is a generalized diagram of computational graphs of a machine learning model.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for performing efficient data storage and data transfer of machine learning data are disclosed. In various implementations, at least the host processing circuit of the computing system executes a machine learning (ML) parallel data application, which is also referred to as a ML model. In some implementations, the ML model is one of a variety of types of a large language model (LLM). The ML application is written by a developer in one of a variety of high-level programming languages such as Python, R, Julia, C, C++, C#, and Java and so on. Machine learning libraries can be used with these high-level programming languages to provide predefined modules to aid developers when building the ML application (ML model). Examples of the ML libraries are TensorFlow, Pytorch, Numpy, Keras, Scikit and so on. A predefined module can be called similar to a function call and the predefined module provides a sequence of execution steps. The execution nodes of the DAG represent the mathematical expressions or operations to perform and the edges of the DAG between the execution nodes represent data dependencies. The imported ML libraries and predefined modules are used to create a computational graph that provides the computational order of the ML nodes, layers and stages of the ML model. The host processing circuit uses a library that relies on a user mode driver (UMD) to translate function calls in the ML application to commands particular to a piece of hardware such as an accelerator circuit with a parallel data microarchitecture.

Based on the computational graph, the accelerator circuit detects the next machine learning (ML) node (or layer) to execute. The accelerator circuit verifies whether non-compressed weights stored in its local memory include weights required for the next ML node. If so, then the accelerator circuit executes the next ML node using the required weights stored in the local memory. Otherwise, if the required weights are unavailable in the local memory for the next ML node, then the accelerator circuit retrieves the required weights from a next lower level of the memory hierarchy such as the system memory. The system memory transfers weights to local memory as the accelerator circuit executes ML layers. Therefore, data transfer of weights is performed in an overlapping manner with the execution of ML layers of the LLM.

When the accelerator circuit determines data storage capacity of its local memory has exceeded a size threshold, the accelerator circuit selects data to offload from the local memory. As used herein, “offload” refers to transferring data from a first data storage device, such as the local memory, currently storing the data to a second data storge device corresponding to another level of the memory hierarchy. No copy of the data being transferred remains at the first data storage device that previously stored the data to offload. Therefore, the offloading (transferring) of data from the first data storage device is typically performed to increase available data storage space of the first data storage device.

The computing system uses a multi-level memory hierarchy where higher levels of the memory hierarchy provide smaller access latencies with smaller data storage capacities than lower levels of the memory hierarchy. However, various implementations may have variations in the latencies and sizes in the memories at various locations within the hierarchy. On-die registers and flip-flop circuits are typically at the highest level of the memory hierarchy with an on-die cache memory subsystem being the immediately next lower level of the memory hierarchy. Secondary storage is typically the lowest level of the memory hierarchy and secondary storage includes one or more of a variety of non-volatile types of data storage devices such as hard disk drives (HDDs), solid-state drives (SSDs), optical discs, and portable flash memory such as USB drives and memory cards or sticks. System memory is typically the immediately next higher level of the memory hierarchy. System memory can be implemented by one of a variety of types of dynamic random-access memory (DRAM). In some implementations, the first data storage device is at a higher level of the memory hierarchy than the second data storage device. As used herein, the “local memory” of the accelerator circuit refers to a memory at the next lower level of the memory hierarchy than the cache memory subsystem of the accelerator circuit (e.g., local memory 980 coupled to cache 1030).

When offloading the selected data from the local memory, the accelerator circuit can compress the selected data beforehand. The accelerator circuit uses a condition to qualify whether compression is performed, and the condition includes balancing data processing capabilities of the computing system and data transfer bandwidth that reduces inference cost. Typically, a computing system transfers weights and other data between levels of the memory hierarchy as the ML model executes based only on which ML layers are currently executing. Accordingly, the efficiency of providing data, such as at least required weights, reduces. In contrast, the proposed solution includes the accelerator circuit conditionally compressing data to offload from local memory while also overlapping the operations used to retrieve data for ML layers and executing other ML layers. To test the qualifying condition to determine whether to compress data before offloading the data from local memory, the accelerator circuit generates a sum of a decompression throughput (“T”) of the accelerator circuit and a data transfer rate (“R”) between the local memory and a next lower level of the memory hierarchy such as the system memory. As used herein, the decompression throughput refers to the rate at which data is decompressed (e.g., an amount of data per unit time). In some implementations, the decompression throughput (“T”) and data transfer rate (“R”) are stored in programmable configuration status registers. In other implementations, these values are measured over a period of time and updated at the end of particular time intervals. The accelerator circuit generates a ratio (“(T+R)/T”) by dividing the sum by the decompression throughput.

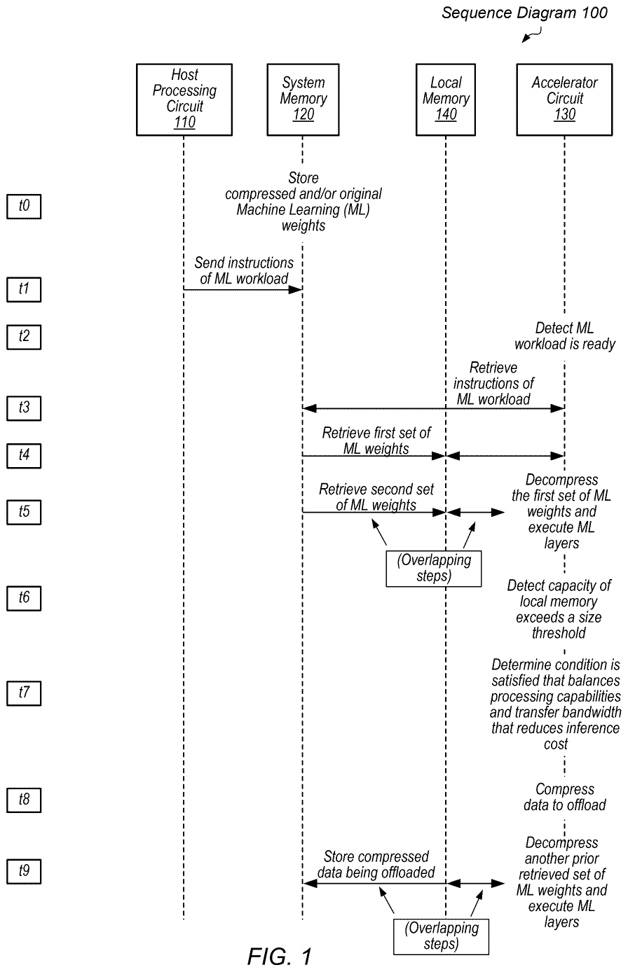

When the accelerator circuit determines the compression ratio (“r”) of the accelerator circuit is greater than the generated ratio, the accelerator circuit compresses the data prior to offloading the data such as by transferring the data from local memory to the next lower level of the memory hierarchy such as the system memory. The accelerator circuit also decompresses other data and executes other ML layers. Therefore, the accelerator circuit concurrently performs multiple operations to increase throughput of the ML model. In various implementations, the data being possibly compressed, transferred and possibly decompressed include the parameters of the ML model. These ML model parameters include data that are generated during training of the ML model and are retained from one inference to another. Examples of the ML parameters (or parameters) that are retained are ML weights and activation function bias values (or bias values). The ML parameters also include ML intermediate data that are not generated during training, but are generated during inference, and are not retained from one inference to another. Examples of the ML intermediate data are activation tensors, query vectors, key vectors, value vectors, context scores and so forth. Further details of these techniques for performing efficient data storage and data transfer of machine learning data are provided in the following description of FIGS. 1-11.

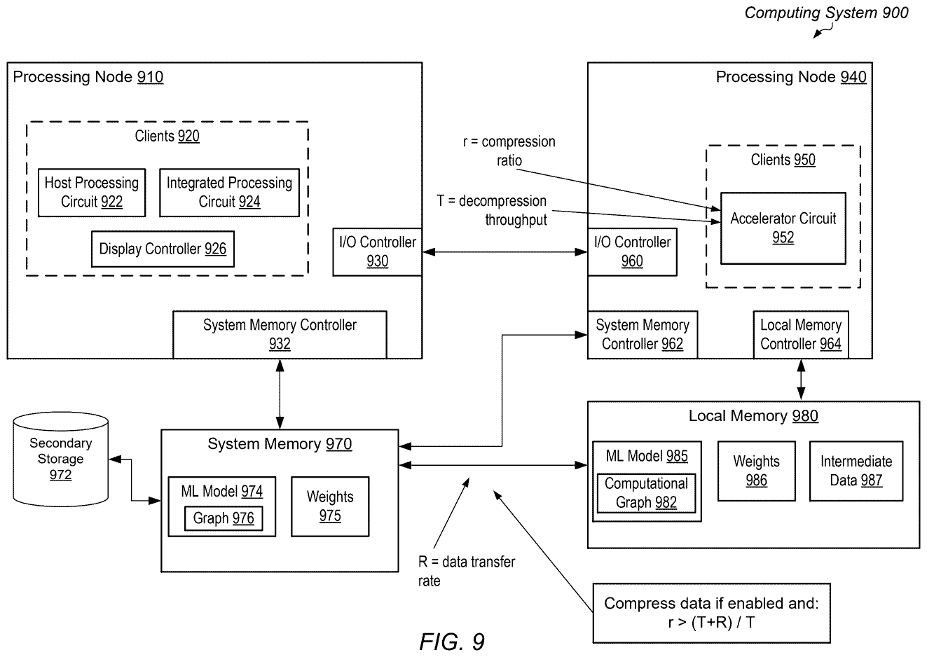

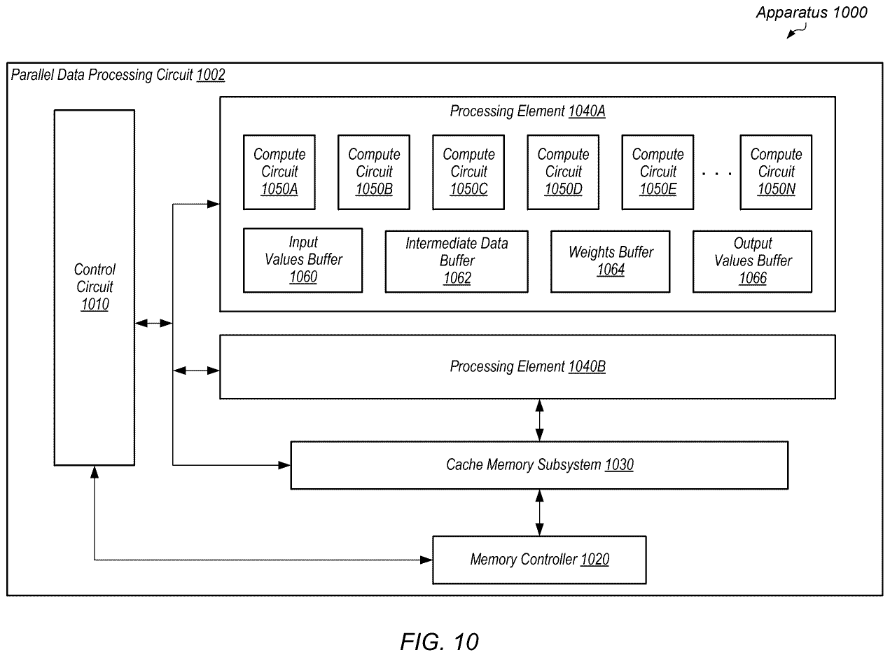

Turning now to FIG. 1, a generalized diagram is shown of a sequence diagram 100 that performs efficient data storage and data transfer of machine learning data. As shown, a computing system includes a host processing circuit 110 connected to system memory 120. The computing system 100 also includes an accelerator circuit 130 connected to each of system memory 120 and local memory 140. In various implementations, the host processing circuit 110 is a general-purpose processing circuit, such as a central processing unit (CPU), that executes instructions of a host operating system of the computing system. The accelerator circuit 130 is a parallel data processing circuit with a highly parallel data microarchitecture. Examples of the accelerator circuit 130 are a graphics processing unit (GPU), a digital signal processing circuit (DSP), a field programmable gate array (FPGA), and an application specific integrated circuit (ASIC). Yet other examples of the accelerator circuit 130 are an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, a multiprocessing circuit, and so on. In various implementations, host processing circuit 110 has the same functionality as host processing circuit 922 (of FIG. 9), and accelerator circuit 130 has the same functionality as accelerator circuit 952 (of FIG. 9) and parallel data processing circuit 1002 of apparatus 1000 (of FIG. 10).

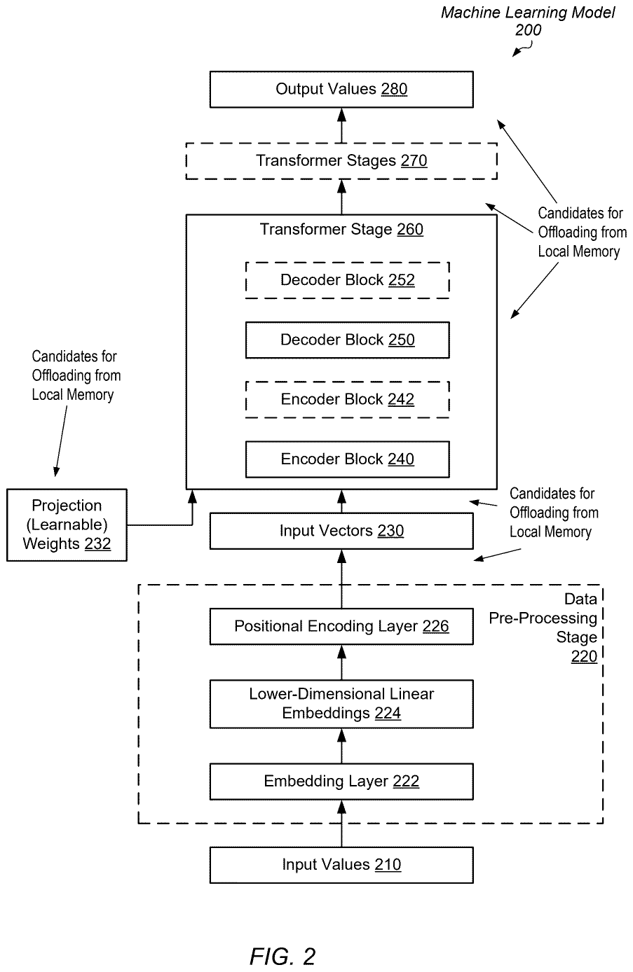

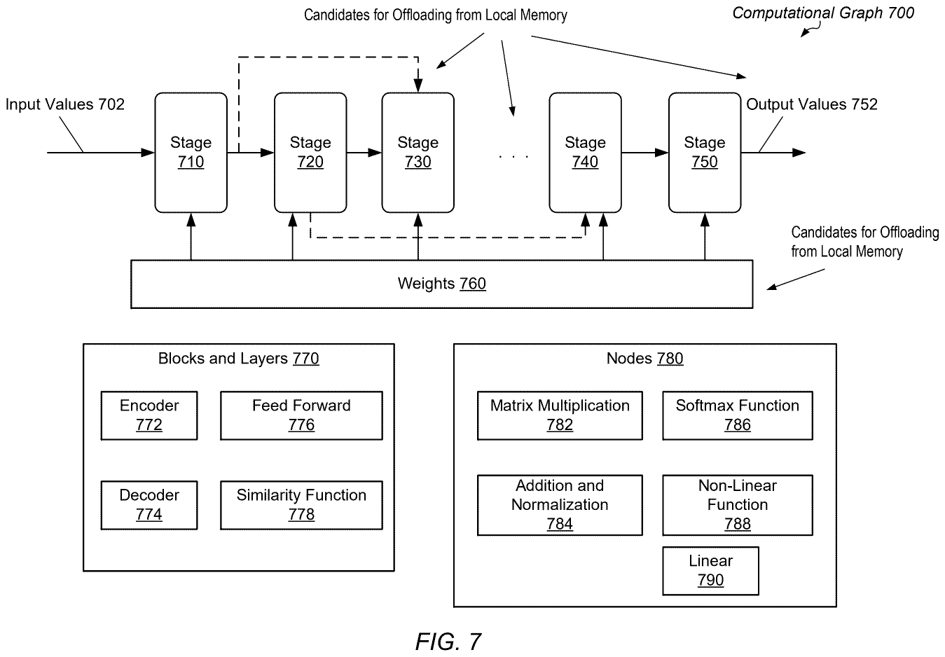

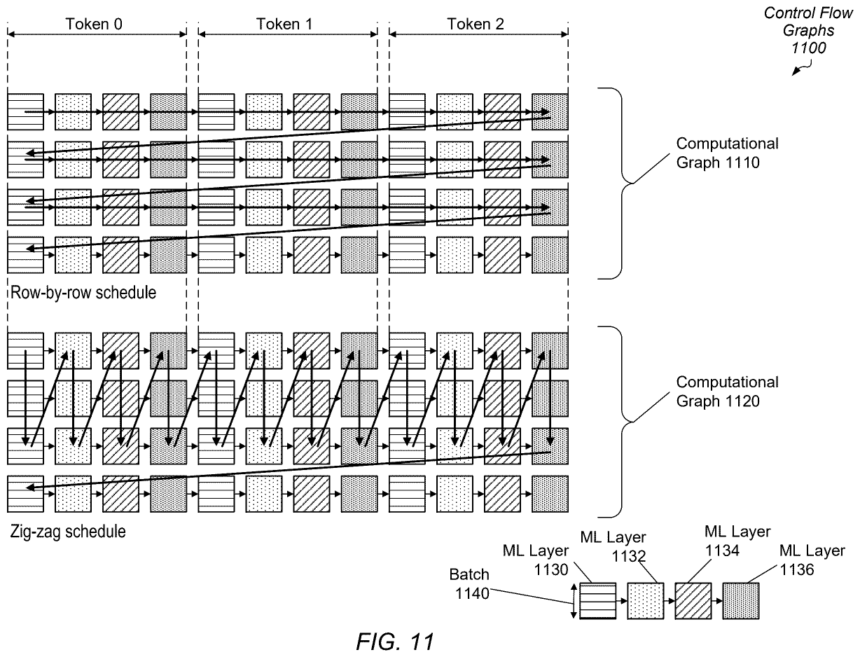

Each of the host processing circuit 110 and accelerator circuit 130 can execute a variety of types of data compression algorithms and data decompression algorithms. Host processing circuit 110 and accelerator circuit 130 execute a variety of types of parallel data applications such as a variety of types of machine learning (ML) models and ML stages, layers and nodes used to construct the ML models. The ML models include multiple trained ML models that use machine learning techniques relying on one of generative adversarial networks (GANs), diffusion models, a recurrent neural network (RNN) structure, a convolutional neural network (CNN) structure, a deep neural network (DNN) structure, a transformer model with an encoder-decoder architecture, and so forth. The neural network structures can be used to construct larger ML models such as generative artificial intelligence (Gen AI) models and large language models (LLMs). An example of the ML model is ML model 200 (of FIG. 2). Typically, one or more of host processing circuit 110 and accelerator circuit 130 executes the instructions of stages, layers and nodes in a computational order based on a computational graph such as computational graph 700 (of FIG. 7) and computational graphs 1110 and 1120 (of FIG. 11).

It is noted that the sequence diagram provided herein are provided for ease of discussion and are not intended to indicate a strict ordering of events. Rather, some of the events may occur concurrently and may occur in a different order. At time t0, system memory 120 stores machine learning (ML) weights of a trained ML model. In an implementation, one or more of host processing circuit 110 and accelerator circuit 130 compress at least a subset of the ML weights (or weights) of the trained ML model. In other implementations, system memory 120 stores all of the weights in their original representation, whereas in other implementations, system memory 120 stores all of the weights in a compressed format. In an implementation, compression is performed without pruning or quantizing the weights. In some implementations, the compressed weights have redundant information removed from a non-compressed version of the weights and during later decompression, the precision of the non-compressed version of the weights is maintained or exceeds a threshold. At this time, the version of the weights being compressed is the original representation of the weights after training of the ML model has completed. During later steps performed at later times, the version of the weights being compressed is a non-compressed representation of weights. As used herein, “non-compressed data” refers to values of the data that are not currently stored in a compressed format and can include an original representation of the data, such as an original representation of weights after training has completed, or a version of the data that has been operated on by a decompression algorithm.

In some implementations, the ML model is one of a variety of types of a large language model (LLM). System memory 120 stores the compressed weights and the non-compressed weights. In an implementation, each of system memory 120 and local memory 140 is one of a variety of types of synchronous random-access memory (SRAM). At time t1, host processing circuit 110 begins processing the instructions of the ML model and a library uses a user mode driver (UMD) to translate function calls in the application to commands particular to a piece of hardware such as accelerator circuit 130. The commands are included in at least a computational graph (not shown) stored in local memory 140 after initial storage in system memory 120. An implementation of the computational graph is provided as computational graph 700 (of FIG. 7) and computational graphs 1110 and 1120 (of FIG. 11). At time t2, accelerator circuit 130 detects the ML workload is ready. In an implementation, host processing circuit 110 directly informs accelerator circuit 130 through a Peripheral Component Interconnect Express (PCIe) bus or accelerator circuit 130 detects a doorbell or flag has been updated in system memory 120. At time t3, accelerator circuit 130 retrieves the instructions of the ML workload.

At time t4, based on the computational graph, accelerator circuit 130 detects a next machine learning (ML) node to execute. Accelerator circuit 130 verifies whether non-compressed weights stored in local memory 140 include weights to be used for the next ML node. If the non-compressed weights are available for the next ML node, then accelerator circuit 130 retrieves the required non-compressed weights from non-compressed weights stored in local memory 140. Following accelerator circuit 130 executes the ML node using the retrieved non-compressed weights. For example, accelerator circuit 130 adds the ML node to a work queue (or machine learning queue or scheduler queue) that includes a pointer to the storage location of the local memory 140 that stores the non-compressed weights. In various implementations, the corresponding activation function bias values (or bias values) are also retrieved. The weights and the bias values are ML model parameters that are generated during training of the ML model and are retained from one inference to another.

The bias values are values added to the weighted sum of inputs prior to the weights sum being passed through the activation function. The bias values allow the ML model to shift the activation function to generate more accurate output values of the ML model. Similar to finding the weights, in an implementation, the bias values are found by backpropagation steps performed during training. If the required weights and bias values are unavailable for the next ML node, then accelerator circuit 130 retrieves the required weights from system memory 120. Based on requests from the accelerator circuit 130, system memory 120 transfers weights and bias values to local memory 140.

At time t5, based on requests from the accelerator circuit 130, system memory 120 continues transferring weights and bias values to local memory 140 as the accelerator circuit 130 executes ML layers. Therefore, data transfer of weights and bias values is performed in an overlapping manner with the execution of ML layers of the LLM. At time t6, the accelerator circuit 130 determines data storage capacity of local memory 140 has exceeded a second size threshold. The accelerator circuit 130 selects data to offload from local memory 140. Candidates for the data to offload from local memory 140 include a variety of types of ML parameters of ML nodes that have completed. These ML model parameters include data that are generated during training of the ML model and are retained from one inference to another. Examples of the ML parameters that are retained are ML weights (or weights) and activation function bias values (or bias values).

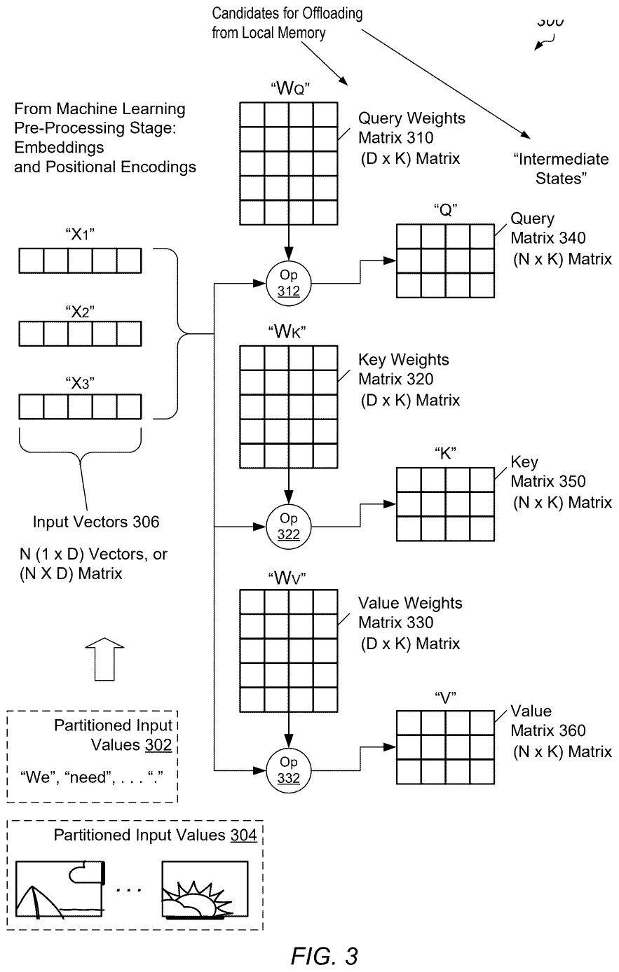

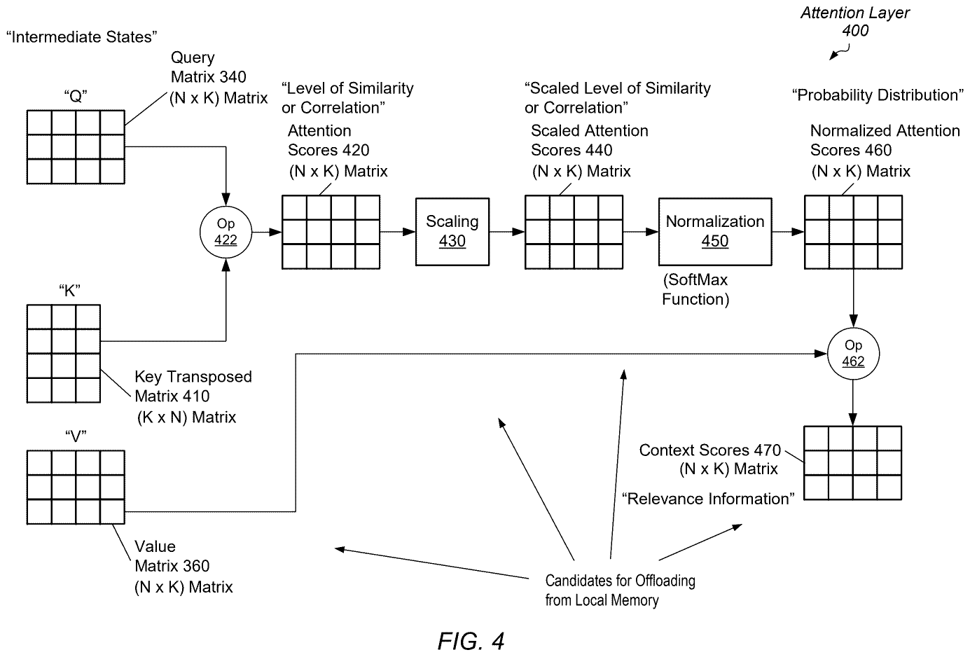

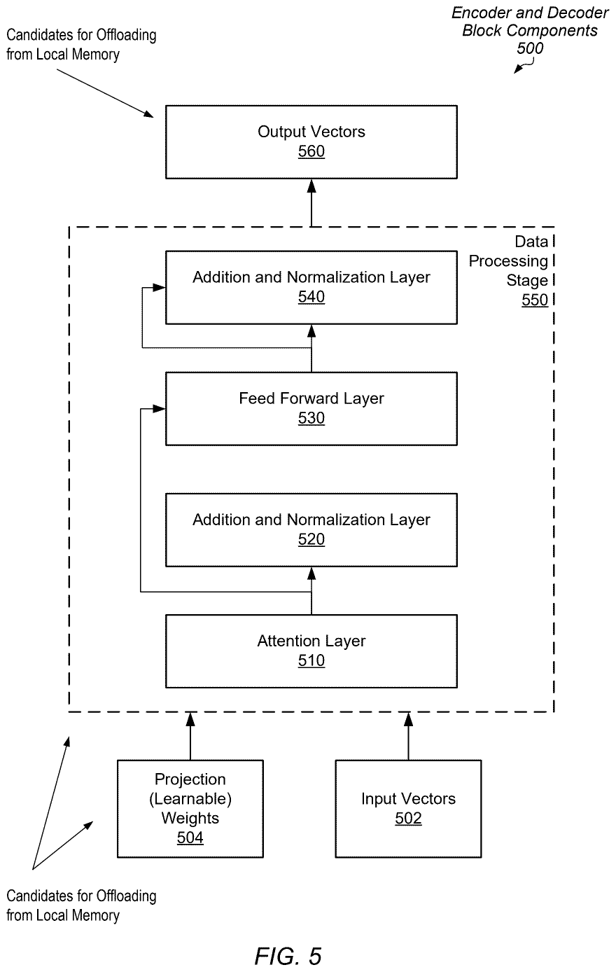

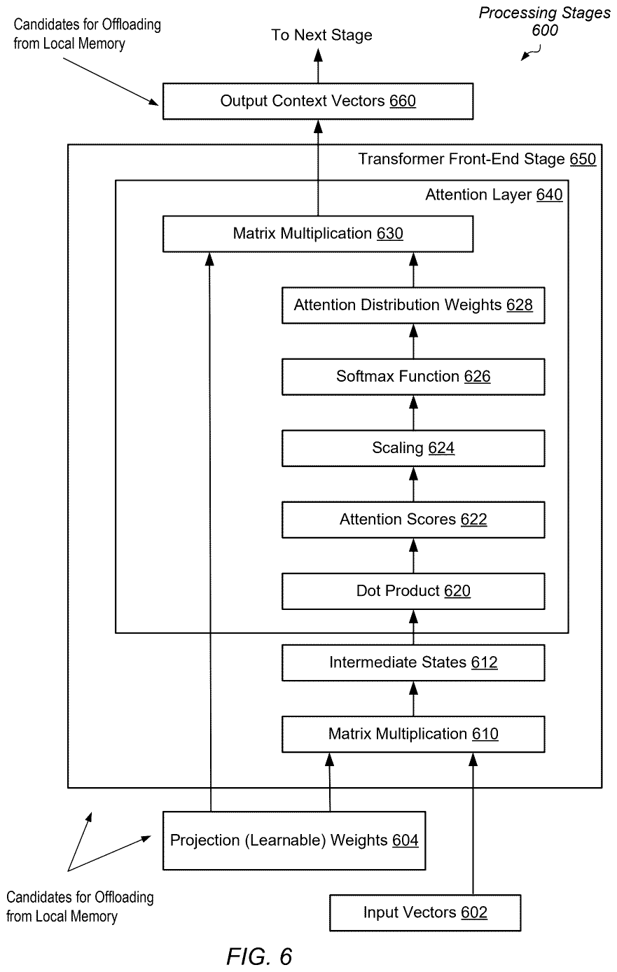

The ML parameters also include ML intermediate data that are not generated during training, but are generated during inference, and are not retained from one inference to another. Examples of the ML intermediate data (or intermediate data) are activation tensors, context scores, query states (query intermediate states or query intermediate matrix or query two-dimensional tensor that includes multiple query vectors such as matrix 340 of FIG. 3), key states (key intermediate states or key intermediate matrix or key two-dimensional tensor that includes multiple key vectors such as matrix 350 of FIG. 3), value states (value intermediate states or value intermediate matrix or value two-dimensional tensor that includes multiple value vectors such as matrix 360 of FIG. 3), and so forth. Other examples of the ML intermediate data being transferred between ML layers and nodes of the ML model are normalized attention scores 460 and context scores 470 (of FIG. 4), output vectors 560 (of FIG. 5), and output context vectors 660 (of FIG. 6), and so forth. The candidate data for offloading are ML parameters that are not going to be used by the immediately next one or more executing ML layer or node of the ML model.

In some implementations, the computing system maintains enable values for data types that can be compressed prior to being offloaded. The computing system stores the enable values in configuration and status registers or other programmable registers. A particular programmable register can store a bit indicating whether a data type of weights is enabled or disabled for compression prior to offloading. Another programmable register can store a bit indicating whether a data type of one of the variety of types of intermediate data weights is enabled or disabled for compression prior to offloading. Besides data type and any programmable enable bits, another qualifier for being a candidate for compression during offloading is the size of the data or the size of a corresponding ML layer (instructions, weights and intermediate data). When the size is greater than a size threshold, the corresponding data qualifies as a candidate for compression during offloading.

When offloading weights and the intermediate data from the local memory 140, the accelerator circuit 130 can compress the offloaded data beforehand. The accelerator circuit 130 uses a condition to qualify whether compression is performed, and the condition includes balancing processing capabilities and transfer bandwidth that reduces inference cost. To test the condition, the accelerator circuit 130 generates a sum of a decompression throughput (“T”) of the accelerator circuit 130 and a data transfer rate (“R”) between the local memory 140 and the system memory 120. In some implementations, the decompression throughput (“T”) and data transfer rate (“R”) are stored in programmable configuration status registers. In other implementations, these values are measured over a period of time and updated at the end of particular time intervals. The accelerator circuit 130 generates a ratio (“(T+R)/T”) by dividing the sum by the decompression throughput.

At time t7, the accelerator circuit 130 determines the compression ratio (“r”) of accelerator circuit 130 is greater than the generated ratio. At time t8, based on the compression ratio (“r”) of accelerator circuit 130 being greater than the generated ratio (“(T+R)/T”), the accelerator circuit 130 (or other circuit such as host processing circuit 110 or another circuit not shown) compresses the weights (and any bias values and any other selected intermediate data) prior to offloading the data such as by transferring the data, at time t9, from local memory 140 to system memory 120. In an implementation, accelerator circuit 130 (or other circuit) compresses the different data types (e.g., weights, bias values, different types of intermediate data) separately, whereas in other implementations, accelerator circuit 130 (or other circuit) compresses the different data types together as a single large chunk of data. In the latter implementation, accelerator circuit 130 (or other circuit) maintains a table or mapping in metadata to track the different data types in the non-compressed format. At time t9, the accelerator circuit 130 also decompresses other weights and executes other ML layers. Therefore, the accelerator circuit 130 concurrently performs multiple operations to increase throughput of the ML model.

Referring to FIG. 2, a generalized diagram is shown of a machine learning model 200 that performs efficient data storage and data transfer of machine learning data. As shown, machine learning model 200 includes data pre-processing stage 220 and transformer stage (or model or layer) 260. In some implementations, machine learning model 200 includes one or more additional transformer stages such as at least transformer stage 270, which is shown in a dashed box since it is optional and can include more than one transformer stage. Data pre-processing stage 220 receives input values 210 and generates input vectors 230, which are sent to transformer stage 260. Transformer stage 260 (and any additional transformer stages 270) uses input vectors 230 to generate output values 280.

By using transformer stages (or models or layers) 260 (and any additional transformer stages 270), machine learning model 200 uses a neural network structure to generate output values 280 from input values 210 based on at least tracking relationships and relevance between elements of an input sequence (input values 210) and tracking long term dependencies or relationships with prior input values 210. Transformer stage (or model or layer) 260 (and any additional transformer stages 270) utilizes attention and self-attention mathematical techniques to track dependencies or relationships among elements of the input values 210 and previous input values. In various implementations, machine learning model 200 is a large language model (LLM), which includes multiple transformer stages relying on self-attention mathematical techniques for processing natural language processing (NLP) applications.

The NLP applications generate content such as answers to questions or paragraphs of an article, provide language translations of sentences and phrases, generate predictions and/or recommendations of search queries, generate classifications of input images, generate images and video frames based on user input, and so forth. Examples of input values 210 are also shown in FIG. 3 as partitioned input values 302, which includes text inputs and punctuation marks of a user query, and partitioned input values 304, which are patches of an input image. Multiple other examples of input values 210 and output values 280 are also possible and contemplated. Examples of LLMs are Generative Pre-trained Transformer 4 (GPT-4) developed by OpenAI, Inc., Large Language Model Meta AI (Llama or LLaMA) developed by Meta AI, Orca developed by Microsoft Corp., Mistral 7B developed by Mistral AI, Stable Diffusion developed by Stability AI, and so forth. Other examples of LLMs are a variety of types of vision transformers (ViT) such as LLMs that utilize Cross-Shaped Window (CSWin) transformer blocks, LLMs that rely on Cross-Attention Multi-Scale Vision Transformer (CrossViT) blocks, LLMs that rely on Data-Efficient Image Transformer (DEIT) blocks, and so forth. In various implementations, ML model 200 utilizes the transformer stage 260 that includes an encoder-decoder architecture that relies on components 500 (of FIG. 5) and processing stages 600 (of FIG. 6) to create ML model 974 (of FIG. 9).

In some implementations, input values 210 are values of a user query that includes a user identifier (ID) and a movie title, a music song title or other item for purchasing or searching that has a corresponding item ID, and the output values 280 include a selection (mouse click) probability on another movie title, song title or other similar item on a web page. In other implementations, input values 210 are input text from a user for a natural language processing (NLP) application. The type of NLP application determines the type of output values 280 generated by transformer stage 260 (and any additional transformer stages 270). The NLP applications can include language translation services, virtual assistants, chatbots, and so forth. In yet other implementations, the input values 210 are patches or subsets of a video frame or an image and the output value 280 is a classification or identifying category of the entire image or multiple classifications of multiple objects in the image. As described earlier, examples of input values 210 are also shown in FIG. 3 as partitioned input values 302, which includes text inputs and punctuation marks of a user query, and partitioned input values 304, which are patches of an input image. Multiple other examples of input values 210 and output values 280 are also possible and contemplated.

Embedding layer 222 of data pre-processing stage 220 converts each input value (or token) of input values 210 to a multi-dimension embedding (embedding vector). In an implementation, the input values 210 includes the sentence “We need coffee.” Each element (word or token or punctuation mark) of the input sequence (sentence that represents input values 210) is converted to a D-dimension embedding vector such as a vector with “D” floating-point numbers where “D” is a positive, non-zero integer. In a simplified implementation, D is 4 and the embedding layer 222 converts the word “coffee” of input values 210 to the 4-dimensional vector (or embedding) equal to [0.674, 0.002, −0.395, 0.983]. Embedding layer 222 performs a similar conversion (mapping) for the other elements (or tokens) “We” and “need” and the punctuation period “.” of the input sequence (input values 210).

In the above example, dimension D is kept small for illustrative purposes. However, in other implementations, another value for dimension D is used based on design requirements. For example, dimension D can be 16, and embedding layer 222 converts the word “coffee” of input values 210 to a 16-dimensional vector (or embedding vector) that includes 16 floating-point numbers. Dimension D can also be 512, and embedding layer 222 converts the word “coffee” of input values 210 to a 512-dimensional vector (or embedding vector) that includes 512 floating-point numbers. In yet other implementations, input values 210 includes three non-overlapping patches or subsets of an image or video frame and embedding layer 222 converts each of the three patches to a D-dimensional vector (or embedding vector). In another example, the image or video frame can be divided into nine respective, non-overlapping and equal-sized patches. When D is 256, the patch that is the top right corner of the image or video frame is converted into an embedding vector with 256 floating-point numbers. Similarly, each of the other eight patches of the total nine patches is converted to a corresponding and unique 256-dimension embedding vector.

Lower dimensional linear embeddings 224 (or embeddings 224) represent the D-dimension vectors (embedding vectors) generated by embedding layer 222. These embeddings 224 are D-dimension numerical representations, which are also referred to as “embedding vectors.” As used herein, each element or individual input value of input values 210 can be referred to as a “token.” In some implementations, each element (or token) of input values 210 is converted into a D-dimension embedding vector by a lookup operation of an embedding table. To generate a D-dimension embedding vector for each of the tokens of input values 210, in some implementations, a variety of mapping techniques can be used to map the embeddings 224 tokens to “latent space vectors” or “latent vectors” or “embedding rows.” Tokenization and mapping cause the original data of input values 210 to be mapped from a higher-dimensional space to a lower-dimensional space while preserving the meaning of the original data. Examples of these other mapping techniques are the Principal Component Analysis (PCA) technique, the Singular Value Decomposition (SVD) technique, the Word2Vec technique, the t-SNE (t-Distributed Stochastic Neighbor Embedding) technique, the UMAP (Uniform Manifold Approximation and Projection) technique, and so forth.

Data pre-processing stage 220 also includes positional encoding 226. Positional encoding layer 226 maps a position of an element of an input sequence, such as input values 210, to a vector of numerical representations. For example, when input values 210 is a sequence of ten textual words or a sequence of ten patches of an image, positional encoding layer 226 provides a unique vector with “D” numerical representations for each of the ten positions within the sequence. Therefore, by using the vectors, positional encoding 226 identifies which textual word or patch is the first element in the sequence of input values 210, identifies which textual word or patch is the second element in the sequence, identifies which textual word or patch is the third element in the sequence, and so on. Positional encoding layer 226 does not use a single numerical value, such as a positional index, for each element of the input sequence since the input sequence can be large and the resulting magnitudes of the indices would be large. The large magnitude would cause the indices to consume a large amount of data storage of the hardware resources of the computing system.

In some implementations, positional encoding layer 226 utilizes one or more of the trigonometric sine function and the trigonometric cosine function to generate the unique numerical representations (positional encoding vectors) to place in the vectors that specify the positional encodings. The frequencies of the selected trigonometric function (sine or cosine) can be set to depend on one or more of the dimension of the embeddings 224, the position of the element in the input sequence (input values 210), the position of the numerical representation within the vector of the element, user-defined values, and so forth. In other implementations, a variety of other functions and methods are used to generate the positional encoding vectors. To generate the input vectors 230, positional encoding layer 226 combines the embedding layer 222 with the positional encoding vectors. In an implementation, for each element of the input sequence (input values 210), positional encoding layer 226 sums each numerical representation in the embedding layer 222 with a corresponding numerical representation of the positional encoding vectors. In other implementations, positional encoding layer 226 combines the embedding layer 222 with the positional encoding vectors using a variety of other mathematical computations.

Transformer stage (or model or layer) 260 receives the input vectors 230 from the data pre-processing stage 230. Transformer stage 260 also receives the projection (learnable) weights 232, which are machine learning weights. Transformer stage 260 generates output values, which are used as outputs of machine learning model 200, such as output values 280, or used as inputs to a subsequent transformer stage such as transformer stage 270. Unlike a recurrent neural network (RNN), such as a long short term memory (LSTM) neural network, and other types of neural networks that are sequential machine learning models relying on recurrence and relationships of nearby elements of an input sequence (input values 210), transformer stage 260 provides parallel processing relying on relationships concurrently across all elements of the input sequence. For example, positional encoding layer 226 provided the relationships in the form of positional encoded vectors to be used by transformer stage 260. These positional encoded vectors were combined with the embeddings 224 to generate the input vectors 230.

As described earlier, transformer stages 260 (and 270) utilize self-attention mathematical techniques. These techniques numerically characterize relationships, dependencies and relevance between tokens of the input values 210. These techniques provide context information among the tokens. For example, the token “store” in a sentence or phrase can be a noun such as a physical building or online website where customers shop for items. The token “store” can also be a verb for holding an item in a location for later use. The context and relationships among other tokens provide the actual meaning of the token “store.” To provide the attention mathematical techniques that include relevance and context information, transformer stage 260 utilizes the projection (learnable) weights 232 (or weights 232). A further description of weights 232 is provided in the description of machine learning initial stage 300 of FIG. 3.

Transformer stage 260 includes one or more encoder blocks, such as encoder block 240 and 242, and one or more decoder blocks, such as decoder block 250 and 252. In various implementations, components of the encoder blocks 240 and 242 and the decoder blocks 250 and 252 are similar. For example, as illustrated in encoder and decoder block components 500 of FIG. 5, encoder and decoder block components can include an attention layer, one or more addition and normalization layers, and a feed forward layer. These layers receive input vectors and generate output vectors. The number and arrangement of the layers is based on a computational graph, such as computational graph 700 of FIG. 7, set up by designers of the machine learning model.

Referring to FIG. 3, a generalized diagram is shown of a machine learning initial attention stage 300 that performs efficient data storage and data transfer of machine learning data. As shown, machine learning initial attention stage 300 (or stage 300) receives input vectors 306 and generates the intermediate states that include the matrices 340, 350 and 360. In various implementations, an embedding layer (not shown), such as embedding layer 222 of data pre-processing stage 220 (of FIG. 2), converts each input value (or token) of partitioned input values 302 or 304 to a multi-dimension embedding (embedding vector) such as one of input vectors 306. Partitioned input values 302 includes text inputs and punctuation marks of a user query. Partitioned input values 304 are patches of an input image. Although shown together, stage 300 utilizes one of the partitioned input values 302 and 304 to generate a particular set of the intermediate states that include the matrices 340, 350 and 360. The partitioned input values 302 and 304 are not mixed together.

As shown, partitioned input values 302 includes text words and punctuation marks of a user query such as a sentence, phrase or question. Each element (word or token or punctuation mark) of the user query is converted to a D-dimension embedding vector such as a vector with “D” floating-point numbers where “D” is a positive, non-zero integer. One of the input vectors 306 represents this D-dimension embedding vector in a simplified implementation. For example, the embedding layer converts the token “We” to the D-dimension embedding vector “X₁” of input vectors 306, converts the token “need” to the D-dimension embedding vector “X₂” of input vectors 306, and so forth. In another implementation, embedding layer converts the token that is a patch or subset of a video frame or still image to the D-dimension embedding vector “X₁” of input vectors 306, converts a second patch to the D-dimension embedding vector “X₂” of input vectors 306, and so forth. A positional encoding layer (not shown), such as positional encoding layer 226 of FIG. 2, combines the embedding vectors with corresponding positional encoding vectors to generate the final numerical representations of input vectors 306. Although three input vectors of input vectors 306 are shown, in various implementations, another number of input vectors is used based on design requirements.

The circuitry (not shown) of stage 300 receives the input vectors 306 and receives the projection (learnable) weights 310, 320 and 330, which are machine learning model weights. The circuitry (not shown) of stage 300 generates the intermediate states that include the matrices 340, 350 and 360. As described earlier, transformer stages utilize self-attention mathematical techniques. These techniques numerically characterize relationships, dependencies and relevance between tokens of the input values and tokens of a database to provide probabilities of correct responses or generative content. These techniques provide context information among the tokens. For example, the token “right” in a sentence or phrase can indicate a direction, which is the opposite of “left,” or it can indicate whether a response is correct or incorrect. The context and relationships among other tokens provide the actual meaning of the token “right.” To provide the attention mathematical techniques, stage 300 utilizes the query weights matrix 310, the key weights matrix 320, and the value weights matrix 330.

In various implementations, the circuitry of stage 300 combines the input vectors 306 into a matrix. The circuitry of operator 312 (“Op 312”) performs matrix multiplication using the query weights matrix 310 and the matrix that includes input vectors 306. Each of the input vectors 306 is a (1×D) vector, and when N vectors are placed together in a matrix, the result is an N×D matrix. The query weights matrix 310 is a (D×K) matrix, and the resulting query matrix 340 is an (N×K) matrix. Here, N, D and K are positive, non-zero integers. Similarly, to generate the key matrix 350, operator 322 performs matrix multiplication using the key weights matrix 320 and the matrix that includes input vectors 306. To generate the values matrix 360, operator 332 performs matrix multiplication using the values weights matrix 330 and the matrix that includes input vectors 306.

Referring to FIG. 4, a generalized diagram is shown of an attention layer 400 of a machine learning model. Although a particular set of operations and an order of operations is shown, it is understood that in other implementations a variety of other steps and orders can be used to provide context scores 470 to a subsequent stage of data processing to indicate an amount of relevance or similarity among received input values. For example, in other implementations, techniques directed to Flash Attention and Paged Attention can be used. As shown, attention layer 400 receives intermediate states and generates the context scores 470. In various implementations, the intermediate states include the query matrix 340 and value matrix 360 (of FIG. 3) and the key transposed matrix 410, which is a transpose of the key matrix 350 (of FIG. 3). The circuitry of the operator 422 performs a dot product of matrices 340 and 410 to generate the attention scores 420. With the query matrix 340 being an (N×K) matrix and the matrix 410 being a (K×N) matrix, the attention scores 420 is an (N×K) matrix. The attention scores 420 provides a numerical representation of the similarities between the query matrix 340 and the key transposed matrix 410. The scaling block 430 multiples each matrix element of the attention scores 420 by a scaling factor to generate the scaled attention scores 440, which includes an (N×K) matrix. Scaling block 430 performs scaling to stabilize the attention layer 400. The multiplication of the matrix elements can lead to very large data values, so the matrix elements are reduced by a scaling factor. In some implementations, the scaling factor is the inverse of the square root of the dimension D. Therefore, each of the matrix elements of the matrix of the attention scores 420 is divided by the square root of the dimension D.

To generate the normalized attention scores 460, the normalization block 450 performs a normalization operation on the scaled attention scores 440. In some implementations, a masking step is performed on scaled attention scores 440 prior to the normalization block 450 is executed. In an implementation, a pruning mask is used on one or more of query matrix 340 and key transposed matrix 410 to replace weights with a value of zero prior to the operator 422 executing on them. Such a pruning mask can also be used on value matrix 360 prior to operator 462 executing on it. It is also possible that the weights in one or more of query matrix 340, key transposed matrix 410, and value matrix 360 have been quantized prior to being sent to a corresponding one of the operator 422 and operator 462. The resulting (N×K) matrix of the normalized attention scores 460 includes each matrix element with a floating-point value between 0 and 1. In various implementations, each row of the resulting (N×K) matrix of the normalized attention scores 460 sums to 1. In some implementations, the normalization operation provides a higher emphasis on higher scaled attention scores and provides a lower emphasis on lower scaled attention scores. Normalization block 450 determines which tokens of an input sequence (input values) should receive more attention for a particular input token. Normalization block 450 generates numerical representations of the relevance of tokens between themselves. When using the normalization block 450, larger scaled attention scores of the scaled attention scores 440 correspond to larger probabilities in the input components will correspond to larger probabilities in the normalized attention scores 460.

In various implementations, normalization block 450 uses the SoftMax function (or

SoftMax function) to perform the normalization operation. For a particular matrix element of a first row of the scaled attention scores 440, the SoftMax function (or softargmax function or normalized exponential function) uses the exponential operation on the matrix element and normalizes the resulting value by dividing the resulting value by the sum of the resulting values of the entire vector. For example, if a vector (row of a matrix) includes the values [0.24, −3.7, 4.3], then the exponentials of each of the elements is [1.27, 0.0247, 73.70]. The sum is (1.27+0.0247+73.70) or 74.99. The SoftMax function result for the first element of the vector is (1.27/74.99) or 0.0169. The SoftMax function result for the vector is [0.0169, 0.000329, 0.983]. These operations are performed for each row (vector) of the scaled attention scores 440 to generate the matrix of the normalized attention scores 560. Afterward, the operator 462 performs matrix multiplication using the matrix of the normalized attention scores 460 and the value matrix 360. The result is the matrix of the context scores 470.

Turning now to FIG. 5, a generalized diagram is shown of encoder and decoder block components 500 of a machine learning model. As shown, encoder and decoder block components 500 (or components 500) receive input vectors 502 and generate output vectors 560 using the data processing stage 550 (or stage 550). In some implementations, stage 550 includes an attention layer 510, one or more addition and normalization layers, such as layers 510 and 540, and a feed forward layer 530. Attention layer 510 generates numerical representations of the relevance of tokens between themselves. Further steps to do this operation are provided in the description of the machine learning initial stage 300 (of FIG. 3), the attention layer 400 (of FIG. 4) and the attention layer 640 (of FIG. 6). The addition and normalization layers 520 and 540 combine values of vectors (rows of matrices) by summing them in some implementations and normalizing them, if necessary. The summation provides a residual connection. Normalization allows output values to not become too large, which allows more layers to be used in the machine learning model.

Feed forward layer 530 typically includes a rectified linear unit (ReLU) layer between two linear layers. The feed forward layer 530 utilizes a multilayer perceptron (MLP) to implement its steps that include feed-forward data movement in hidden layers with no loops. In various implementations, each of the linear layers includes its own set of weights (query weight matrix, key weight matrix, value weight matrix) and performs the steps described for machine learning initial attention stage 300 (of FIG. 3). Therefore, the number of weights can increase considerably, especially when the number of layers increase and the number of encoder blocks and decoder blocks increase. As described earlier, the transformer stage 260 (of FIG. 2) can have any number of encoder blocks 240 and 242 and any number of decoder blocks 250 and 252. In an implementation, there are 6 of each of the encoder blocks and decoder blocks. The inputs to the decoder blocks can originate from the outputs of one or more encoder blocks and one or more decoder blocks. Therefore, the attention techniques are repeated and are based on different layers of the transformer model (or stage or layer). The order of operations and the inputs used for different layers and sub-layers are described in a computational graph such as computational graph 700 (of FIG. 7) and computational graphs 1110 and 1120 (of FIG. 11).

Turning now to FIG. 6, a generalized diagram is shown of processing stages 600 of a transformer of a machine learning model. Although a particular set of operations and blocks are shown and a particular order of operations is shown, it is understood that in other implementations a variety of other steps and orders can be used to provide context output vectors 660 to a subsequent stage of data processing. As shown, processing stages 600 includes transformer front-end stage 650 that receives input vectors 602 and the projection (learnable) weights 604 (or weights 604) and generates output context vectors 660. The transformer front-end stage 650 (or stage 650) includes the similarity function 640, which receives the intermediate states 612 and weighs 604 and generates the output context vectors 660. In various implementations, the input vectors 602 have the format and functionality of input vectors 230 (of FIG. 2), input vectors 306 (of FIG. 3) and input vectors 502 (of FIG. 5). The weights 604 have the format and functionality of weights 232 (of FIG. 2), weight matrices 310, 320 and 330 (of FIG. 3) and weights 504 (of FIG. 5).

During a training phase of the large language model (LLM), multiple initial values of weights and thresholds are input into the LLM, which is executed with multiple iterations until results are determined to be correct above a threshold number of times. The training process is an iterative process that generates a set of weight values used for mapping the input data received to the output results. The weights can be optimized for a particular system architecture of a computing device. In some implementations, the training process utilizes unsupervised learning where input data values are provided with no label (expected result). In other implementations, at least a portion of the training process is supervised and includes labels.

In various implementations, transformer front-end stage 650 includes circuitry that performs the operations illustrated in machine learning initial attention stage 300 (of FIG. 3) and attention layer 400 (of FIG. 4). Matrix multiplication block 610 performs matrix multiplication of input vectors 602 arranged as a matrix and particular matrices of weights 604. In some implementations, matrix multiplication block 610 performs the steps shown in stage 300 (of FIG. 3) to generate the intermediate states 612, which have the format and functionality of the intermediate states shown in stage 300 (of FIG. 3) and attention layer 400 (of FIG. 4). To generate the attention scores 622, the dot product block 620 performs the dot product operation on the key matrix of the intermediate states 612 and the transpose of the key matrix of the intermediate states 612. This is a similar operation performed by operator 422 to generate attention scores 420 (of FIG. 4). Scaling block 624 performs scaling to stabilize the similarity function 640. The multiplication of the matrix elements can lead to very large data values, so the matrix elements are reduced by a scaling factor. In some implementations, the scaling factor is the inverse of the square root of the dimension D.

To generate the attention distribution weights 628, the SoftMax function block 626 performs the SoftMax function on the matrix elements of the scaled attention scores from the scaling block 624. In some implementations, a masking step is performed on scaled attention scores prior to the SoftMax function block 626 is executed. This is a similar operation performed by normalization block 450 (of FIG. 4). The matrix multiplication block 630 performs matrix multiplication of the matrix of the attention distribution weights 628 and the values matrix of weights 604. This is a similar operation performed by operator 462 (of FIG. 4). The resulting output context vectors 660 are sent as an output to the next stage of a large language model (LLM) or as the final results of the LLM.

Turning now to FIG. 7, a generalized diagram is shown of a computational graph 700 of a machine learning model. As shown, computational graph 700 includes multiple stages 710-750 that receives the input values 702 and generates the output values 752. The input values 702 have the format and functionality of input values 210 (of FIG. 2) and the output values 752 have the format and functionality of output values 280 (of FIG. 2). Each of the stages 710-750 includes one or more of the blocks and layers 760 and the nodes 780. The computational graph 700 is a graph that visually represents the computational order of operations to perform to implement a machine learning model, the types of operations to perform, and the data dependencies between the operations to perform. In an implementation, the hierarchy of the computational graph 700 has the stages at the highest level followed by blocks and layers and has the nodes at the lowest level. In other implementations, the terms “stage,” “block,” “layer,” and “node” are used differently to represent a different hierarchy. In computational graph 700, the solid arrows represent edges that indicate the data dependencies. The dashed arrows represent possible data dependencies, which are included in one representation of computational graph 700 but not in another implementation.

Although a particular number and type of stages, blocks, layers and nodes are shown, in other implementations, other types of these components and another number of these components are used, and different available versions of the components are possible and contemplated. The stages 710-750 include one or more of the components of the blocks and layers 760 and the nodes 780. In an implementation, some of the stages 710-750 include the same functionality and subsets of multiple stages of stages 710-750 include the same functionality. However, different input values and different weights are processed. For example, the stages 710-750 receive corresponding weights of the machine learning weights 760 (or weights 760). The weights 760 are set during a training process.

In some implementations, the blocks and layers 770 include the encoder block 772, the decoder block 774, the feed forward layer 776 and the similarity function 778. In an implementation, these blocks have the same functionality described earlier for similar components of machine learning model 200 (of FIG. 2), the components 500 (of FIG. 5), and processing stages 600 (of FIG. 6). In an implementation, the nodes 780 include the matrix multiplication node 782, the addition and normalization node 784, the SoftMax function node 786, the non-linear function node 788, and the linear node 790. The non-linear node 788 can include one of a variety of types of non-linear functions such as a rectified linear unit (ReLU) function, a Gaussian error linear unit (GELU) function, a Sigmoid function, a Swish gated linear unit (SwigLU) function, and so forth. Examples of the intermediate data being transferred between stages 710-750 and between blocks 770 and nodes 780 are intermediate states, such as matrices 340, 350 and 360 (of FIG. 3), normalized attention scores 460 and context scores 470 (of FIG. 4), output vectors 560 (of FIG. 5), and output context vectors 660 (of FIG. 6). Designers construct computational graph 700 to provide the functionality of the desired machine learning model such as at least machine learning model 200 (of FIG. 2).

In various implementations, the ML model is written by a developer in one of a variety of high-level programming languages such as Python, R, Julia, C, C++, C#, and Java and so on. Machine learning libraries can be used with these high-level programming languages to provide predefined modules to aid developers when building the ML application (ML model). Examples of the ML libraries are TensorFlow, Pytorch, Numpy, Keras, Scikit and so on. A predefined module can be called similar to a function call and the predefined module includes a directed acyclic graph (DAG) providing a sequence of execution steps of a non-recurring computation. The layers 770 and nodes 780 provide the predefined modules to use in stages 710-750. The execution nodes of the DAG represent the predefined modules providing the mathematical expressions or operations to perform. Similar to the solid and dashed lines between stages 710-750, within each of the stages 710-750, there are lines representing the data flow between the predefined modules. These lines are also referred to as edges, and the edges of the DAG between the execution nodes represent data dependencies. The imported ML libraries and predefined modules are used to create computational graph 700.

For method 800, a computing system includes multiple processing circuits.

Examples of the host processing circuit of the multiple processing circuits are host processing circuit 110 (of FIG. 1) and host processing circuit 922 (of FIG. 9). Examples of the accelerator circuit of the multiple processing circuits are accelerator circuit 130 (of FIG. 1), accelerator circuit 952 (of FIG. 9) and parallel data processing circuit 1002 (of FIG. 10). For method 800, the multiple processing circuits execute a variety of types of parallel data applications such as a variety of types of machine learning (ML) models.

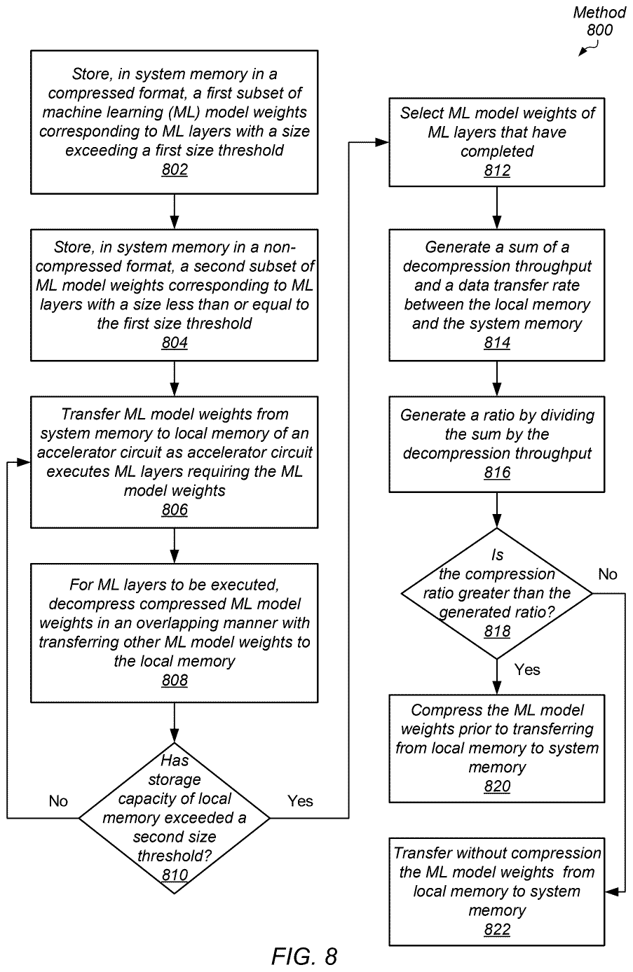

Referring to FIG. 8, a generalized diagram is shown of a method 800 for performing efficient data storage and data transfer of machine learning data. For purposes of discussion, the steps in this implementation are shown in sequential order. However, in other implementations some steps occur in a different order than shown, some steps are performed concurrently, some steps are combined with other steps, and some steps are absent.

In various implementations, machine learning model weights (or weights) have set values based on training of a corresponding machine learning model such as a large language model (LLM). During the training phase of the LLM, multiple initial values of weights and thresholds are input into the LLM, which is executed with multiple iterations until results are determined to be correct above a threshold number of times. The training process is an iterative process that generates the final values of the weights used during inference for mapping the input data received to output results. System memory stores, in a compressed format, a first subset of machine learning (ML) model weights corresponding to ML layers with a size exceeding a first size threshold (block 802). In an implementation, the size of the ML layers and the size threshold are measured by one or more of the number of weights used by the ML layer, a number of sub-layers in the ML layer, a data storage capacity of the ML weights, a number and type of operations in the ML layer, a number of matrices or dimensions of the matrices of the weights, and so forth.

System memory stores, in a non-compressed format, a second subset of ML model weights corresponding to ML layers with a size less than or equal to the first size threshold (block 804). The host processing circuit of the computing system executes a machine learning parallel data application. In various implementations, the application is written by a developer in one of a variety of high-level programming languages such as such as C, C++, and Java and so on. In some implementations, the application includes a computational graph such as computational graph 700 (of FIG. 7) and computational graphs 1110 and 1120 (of FIG. 11). The host processing circuit begins processing the application and a library uses a user mode driver (UMD) to translate function calls in the application to commands particular to a piece of hardware such as one of the other processing circuits. In various implementations, this other processing circuit is a parallel data processing circuit, such as an accelerator circuit, and the application utilizes a large language model (LLM). Based on requests from the accelerator circuit, system memory transfers ML model weights to local memory of the accelerator circuit as the accelerator circuit executes ML layers requiring the ML model weights (block 806). Therefore, data transfer of ML weights is performed in an overlapping manner with the execution of ML layers of the LLM.

For ML layers to be executed, the accelerator circuit decompresses the compressed

ML model weights in an overlapping manner while transferring other ML model weights to the local memory (block 808). If the accelerator circuit determines data storage capacity of local memory has not exceeded a second size threshold (“no” branch of the conditional block 810), then control flow of method 800 returns to block 806 where based on requests from the accelerator circuit, system memory transfers ML model weights to local memory of the accelerator circuit as the accelerator circuit executes ML layers requiring the ML model weights.

If the accelerator circuit determines data storage capacity of local memory has exceeded the second size threshold (“yes” branch of the conditional block 810), then the accelerator circuit selects ML model weights of ML layers that have completed (block 812). The accelerator circuit selects data to offload from local memory that can include at least the ML model weights of ML layers that have completed. Candidates for the data to offload from local memory include these ML weights that have completed and intermediate data. Examples of the intermediate data being transferred between ML layers and nodes of the ML model are intermediate states, such as matrices 340, 350 and 360 (of FIG. 3), normalized attention scores 460 and context scores 470 (of FIG. 4), output vectors 560 (of FIG. 5), and output context vectors 660 (of FIG. 6), and so forth. The candidates (candidate data) for offloading are data stored in local memory that is not going to be used by the next executing ML layer or node of the ML model. In some implementations, the accelerator circuit also selects intermediate data of the ML layers that have been completed. The intermediate data includes at least activation tensors, key vectors and value vectors of corresponding matrices. For example, the intermediate data can include vectors (rows) of one or more of the query matrix 340, the key matrix 350, the values matrix 360 of FIG. 3, attention scores matrix 420 and context scores matrix 470 of FIG. 4, other outputs of layers 510-540 of encoder and decoder block components 500 of FIG. 5, and one or more outputs of sub-layers and layers of processing stages 600 of FIG. 6. The accelerator circuit generates a sum of a decompression throughput of the accelerator circuit and a data transfer rate between the local memory and the system memory (block 814). In some implementations, the decompression throughput and data transfer rate are stored in programmable configuration status registers. In other implementations, these values are measured over a period of time and updated at the end of particular time intervals.

The accelerator circuit generates a ratio by dividing the sum by the decompression throughput (block 816). In an implementation, these computations are the same computations for comparing “r” and “(T+R)/T” at time t7 of sequence diagram 100 (of FIG. 1). In some implementations, the computing system maintains enable values for data types that can be compressed prior to being offloaded. The computing system stores the enable values in configuration and status registers or other programmable registers. A particular programmable register can store a bit indicating whether a data type of weights is enabled or disabled for compression prior to offloading. Other programmable registers are used for other data types. Therefore, it is possible and contemplated that not all selected data for offloading can be a candidate for compression. Besides data type and any programmable enable bits, another qualifier for being a candidate for compression during offloading is the size of the data or the size of a corresponding ML layer (instructions, weights and intermediate data). When the size is greater than a size threshold, the corresponding data qualifies as a candidate for compression during offloading.

If the compression ratio is greater than the generated ratio (“yes” branch of the conditional block 818), then the accelerator circuit compresses the qualified and selected candidate ML model weights (and any other selected intermediate data) prior to transferring the data from local memory to system memory (block 820). Otherwise, if the compression ratio is less than or equal to the generated ratio (“no” branch of the conditional block 818), then the accelerator circuit transfers without compression the ML model weights (and any other selected intermediate data) from local memory to system memory (block 822). Therefore, when offloading weights and the intermediate data from the local memory, the accelerator circuit can compress the offloaded data beforehand. A condition used to qualify whether compression is performed includes balancing processing capabilities and transfer bandwidth that reduces inference cost such as using the generated ratio and subsequent comparison.

Turning now to FIG. 9, a generalized diagram is shown of a computing system 900 that performs efficient data storage and data transfer of machine learning data. As shown, computing system 900 includes the processing nodes 910 and 940, system memory 970, and local memory 980. The hardware, such as circuitry, of each of the first processing node 910 and the second processing node 940 provides a variety of functionalities. For example, the first processing node 910 includes numerous semiconductor dies such as the clients 920 and the second processing node 940 includes the clients 950. As used herein, a “client” refers to an integrated circuit with data processing circuitry and internal memory, which has tasks assigned to it by a scheduler such as an operating system (OS) scheduler or other. Examples of tasks are software threads of a process of an application, which are scheduled by the OS scheduler.

Examples of clients are a general-purpose central processing unit (CPU), a parallel data processing unit with a relatively wide single-instruction-multiple-data (SIMD) microarchitecture, a multimedia integrated circuit, one of a variety of types of an application specific integrated circuit (ASIC), a digital signal processor (DSP), a field programmable gate array (FPGA), one or more microcontrollers, and so forth. Other examples of the parallel data processing circuit are a graphics processing unit (GPU), an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, a multiprocessing circuit, and so on. For example, the clients 920 of the processing node 910 include at least the host processing circuit 922, the integrated processing circuit 924, such as an integrated GPU (or iGPU), and the display controller 926. The clients 950 of the processing node 940 includes at least the accelerator circuit 952. Clock sources, such as phase lock loops (PLLs), an interrupt controller, a communication fabric, power controllers, and so forth are not shown in the computing system 900 for ease of illustration. It is also noted that the number of components of the computing system 900 and the number of subcomponents for those shown in FIG. 9, such as within the clients 920 and 950, can vary from implementation to implementation. There can be more or fewer of each component/subcomponent than the number shown for the computing system 900.

In an implementation, the processing node 910 is a system on a chip (SoC) in a semiconductor package on a motherboard and the system memory 970 is one of a variety of types of synchronous random-access memory (SRAM) in a separate semiconductor package on the motherboard. The processing node 910 accesses system memory 970 while processing tasks of a workload. The processing node 910 uses the system memory controller 932 to transfer data with the system memory 970 via a corresponding communication channel that is a point-to-point communication channel. The address information, command information, response data, payload data, header information, and other types of information are transferred on metal traces or wires that are accessible by only the single source and the single destination. In various implementations, processing node 940 uses the system memory controller 962 to transfer data with the system memory 970 via a corresponding communication channel that is also a point-to-point communication channel. In an implementation, the system memory controller 932, the system memory controller 962, and the system memory 970 support one of a variety of types of a Double Data Rate (DDR) communication protocol or one of a variety of types of a Low-Power Double Data Rate (LPDDR) communication protocol.

Secondary storage 972 is a lower level than system memory 970 in the memory hierarchy of computing system 900. Secondary storage 972 includes one or more of a variety of non-volatile types of data storage devices such as hard disk drives (HDDs), solid-state drives (SSDs), optical discs, and portable flash memory such as USB drives and memory cards or sticks. The processing node 940 accesses the local memory 980 while processing tasks of a workload. Local memory 980 can be on-chip memory or off-chip memory. Therefore, although local memory 980 is shown as being separate from processing node 940, in other implementations, local memory 980 is located within processing node 940. In an implementation, the processing node 940 is a system on a chip (SoC) in a semiconductor package on the motherboard and the local memory 980 is one of a variety of types of SRAM located nearby to processing node 940. In another implementation, processing nodes 910 and 940 are located on the same SoC. The processing node 940 uses the local memory controller 964 to transfer data with the local memory 980. In an implementation, the local memory controller 964 supports one of a variety of types of a Graphics Double Data Rate (GDDR) communication protocol.

Between input/output (I/O) controllers 930 and 960, the communication channel transfers data between integrated circuits of the processing nodes 910 and 940. In an implementation, the I/O interfaces 930 and 960 support a communication protocol such as the Peripheral Component Interconnect Express (PCIe) protocol. Similar to other interfaces, such as the system memory controllers 932 and 962 and local memory controller 964, the I/O controllers 930 and 960 include one or more queues for storing requests, responses, and messages, and include circuitry that builds packets for transmission, disassembles packets upon reception, and supports a particular communication protocol.

In various implementations, accelerator circuit 952 executes a variety of types of parallel data applications such as machine learning (ML) models. System memory 970 stores instructions describing one or more algorithms of machine learning (ML) model 974 that analyze data to generate one or more predictions or classifications. In various implementations, to generate predictions or classifications, ML model 974 has the functionality of ML model 200 (of FIG. 2), processing stages 600 (of FIG. 6), and computational graph 700 (of FIG. 7) and computational graphs 1110 and 1120 (of FIG. 11). In various implementations, ML model 974 is written by developers in one of a variety of high-level programming languages such as Python, R, Julia, C, C++, C#, and Java and so on. Machine learning libraries can be used with these high-level programming languages to provide predefined modules to aid developers when building the ML application (ML model). Examples of the ML libraries are TensorFlow, Pytorch, Numpy, Keras, Scikit and so on.

A predefined module can be called similar to a function call. The imported ML libraries are used to create computational graphs that provide the computational order of the ML nodes, layers and stages of the ML model. For example, accelerator circuit 952 executes instructions of nodes, layers and stages of ML model 985 in a computational order of computational graph 982. Computational graph 982 has the form of computational graph 700 (of FIG. 7) and computational graphs 1110 and 1120 (of FIG. 11). Here, ML model 985 stored in local memory 980 is a copy of ML model 974 stored in system memory 970. Computational graph 982 stored in local memory 980 is a copy of computational graph 976 stored in system memory 970.

System memory 970 stores weights 975. In various implementations, weights 975 have values of an original representation of weights found during training of ML model 974. In some implementations, ML model 974 is one of a variety of types of a large language model (LLM). In some implementations, one or more of clients 920 and 950 compress at least a subset of weights 975 stored in system memory 970, whereas in other implementations, all of weights 975 remain in the original representation. When compression is performed on the weights, in an implementation, compression is performed without pruning or quantizing the weights. The compressed weights have redundant information removed from either a non-compressed version or an original representation of the weights and precision is maintained during later decompression. Therefore, precision of the weights is not reduced when the weights are non-compressed.

When compression of weights 975 is used, in an implementation, memory 970 stores both compressed weights and non-compressed weights. System memory 970 stores, in a compressed format, a first subset of weights corresponding to ML layers with a size exceeding a first size threshold. System memory 970 stores, in a non-compressed format, a second subset of weights corresponding to ML layers with a size less than or equal to the first size threshold. In an implementation, the size of the ML layers and the size threshold are measured by one or more of the number of weights used by the ML layer, a number of sub-layers in the ML layer, a data storage capacity of the ML weights, a number and type of operations in the ML layer, a number of matrices or dimensions of the matrices of the weights, and so forth. Host processing circuit 922 begins processing the instructions of the ML model and a library uses a user mode driver (UMD) to translate function calls in the application to commands particular to a piece of hardware such as accelerator circuit 952. The commands are included in at least computational graph 982 stored in local memory 980 after initial storage in system memory 970.

Based on the computational graph 982, accelerator circuit 952 detects a next machine learning (ML) node of ML model 985 to execute. Accelerator circuit 952 verifies whether non-compressed weights 986 stored in local memory 980 include weights to be used for the next ML node. The required weights of weights 986 can be stored in a compressed format or a non-compressed format. If the non-compressed weights are available for the next ML node, then accelerator circuit 952 retrieves the required non-compressed weights from non-compressed weights 986 stored in local memory 980. Following, accelerator circuit 952 executes the ML node using the retrieved non-compressed weights. For example, accelerator circuit 952 adds the ML node to a work queue (or machine learning queue or scheduler queue) that includes a pointer to the storage location of the local memory 980 that stores the non-compressed weights.

If the required non-compressed weights are unavailable for the next ML node, then accelerator circuit 952 retrieves the required weights from system memory 970. Based on requests from the accelerator circuit 952, system memory 970 transfers weights to local memory 980 as the accelerator circuit 952 executes ML layers. Therefore, data transfer of weights is performed in an overlapping manner with the execution of ML layers of the LLM. Accelerator circuit 952 decompresses any compressed weights retrieved from system memory 970 and stores the non-compressed weights as non-compressed weights 986 in local memory 980. In some implementations, the weights are retrieved and non-compressed “just-in-time” as the ML model needs them, which provides tight synchronization between storage of required weights and usage of the required weights during execution of the corresponding ML nodes, layers and stages.

If the accelerator circuit 952 determines data storage capacity of local memory 980 has exceeded a second size threshold, then the accelerator circuit 952 selects data to offload from local memory 980. Candidates for the data to offload from local memory 980 include the weights of ML layers that have completed and intermediate data 987. Examples of the intermediate data 987 being transferred between ML layers and nodes of the ML model are intermediate states, such as matrices 340, 350 and 360 (of FIG. 3), normalized attention scores 460 and context scores 470 (of FIG. 4), output vectors 560 (of FIG. 5), and output context vectors 660 (of FIG. 6), and so forth. The candidates for offloading are data that is not going to be used by the immediately next executing ML layer or node of the ML model. For example, the intermediate data 987 can include vectors (rows) of one or more of the query matrix 340, the key matrix 350, the values matrix 360 of FIG. 3, attention scores matrix 420 and context scores matrix 470 of FIG. 4, other outputs of layers 510-540 of encoder and decoder block components 500 of FIG. 5, and one or more outputs of sub-layers and layers of processing stages 600 of FIG. 6.

The accelerator circuit 952 generates a sum of a decompression throughput (“T”) of the accelerator circuit 952 and a data transfer rate (“R”) between the local memory 980 and the system memory 970. In some implementations, the decompression throughput (“T”) and data transfer rate (“R”) are stored in programmable configuration status registers. In other implementations, these values are measured over a period of time and updated at the end of particular time intervals. The accelerator circuit 952 generates a ratio (“(T+R)/T”) by dividing the sum by the decompression throughput. If the compression ratio (“r”) of accelerator circuit 952 is greater than the generated ratio, then the accelerator circuit 952 compresses the weights (and any other selected intermediate data) prior to offloading the data such as by transferring the data from local memory 980 to system memory 970. Otherwise, if the compression ratio is less than or equal to the generated ratio, then the accelerator circuit 952 offloads the data by transferring without compression the weights (and any other selected intermediate data) from local memory 980 to system memory 970. Therefore, when offloading weights and the intermediate data from the local memory 980, the accelerator circuit can compress the offloaded data beforehand. A condition used to qualify whether compression is performed includes balancing processing capabilities and transfer bandwidth that reduces inference cost.

Turning now to FIG. 10, a block diagram is shown of an apparatus 1000 that performs efficient data storage and data transfer of machine learning data. In one implementation, apparatus 1000 includes parallel data processing circuit 1002. As shown, parallel data processing circuit 1002 includes control circuit 1010, memory controller 1020, cache memory subsystem 1030 and processing elements 1040A-1040B. Examples of parallel data processing circuit 1002 are the same as examples of accelerator circuit 130 (of FIG. 1) and accelerator circuit 952 (of FIG. 9). In various implementations, parallel data processing circuit 1002 executes a variety of types of parallel data applications such as machine learning (ML) models. For example, parallel data processing circuit 1002 executes instructions of nodes, layers and stages of a ML model in a computational order of a computational graph such as computational graph 700 (of FIG. 7) and computational graphs 1110 and 1120 (of FIG. 11).

Parallel data processing circuit 1002 includes at least control circuit 1010, processing elements 1040A-1040B, cache memory subsystem 1030, and memory controller 1020. Each of processing elements 1040A-1040B includes the multiple compute circuits 1050A-1050N and multiple buffers such as input values buffer 1060, intermediate data buffer 1062, weights buffer 1064 and output values buffer 1066. It should be understood that the components and connections shown for parallel data processing circuit 1002 are merely representative of one type of processing circuit and does not preclude the use of other types of processing circuits for implementing the techniques presented herein. The apparatus 1000 also includes other components which are not shown to avoid obscuring the figure such as at least a communication fabric, one or more system buses, clock signal generating circuitry, power management circuitry, input/output (I/O) interfaces and so on. In other implementations, the parallel data processing circuit 1002 includes other components, omits one or more of the illustrated components, has multiple instances of a component even if only one instance is shown in the apparatus 1000, and/or is organized in other suitable manners. Also, each connection shown in apparatus 1000 is representative of any number of connections between components. Additionally, other connections can exist between components even if these connections are not explicitly shown in apparatus 1000.

In some implementations, parallel data processing circuit 1002 includes interfaces to one or more memories such as a local memory, system memory and one or more other external storage. Although a single memory controller 1020 is shown, it is possible and contemplated that parallel data processing circuit 1002 includes multiple memory controllers supporting one or more communication protocols with a variety of data storage devices. In an implementation, memory controller 1020 (and any other memory controller) directly communicates with each of the processing elements 1040A-1040B and cache memory subsystem 1030 and includes circuitry for supporting communication protocols and queues for storing requests and responses. As part of executing an application, such as an ML model, a host CPU (not shown) launches kernels to be executed by parallel data processing circuit 1002. Control circuit 1010 receives kernels from the host CPU either directly or via system memory and determines when to dispatch kernels for execution on compute circuits 1050A-1050N of processing elements 1040A-1040B.

Parallel threads executing on compute circuits 1050A-1050N read data from and write data to the cache memory subsystem 1030, vector general-purpose registers, scalar general-purpose registers, and one or more of buffers 1060-1066. In various implementations, the circuitry of processing element 1040B is a replicated instantiation (or silicon integrated circuit copy) of the circuitry of processing element 1040A. In some implementations, each of the processing elements 1040A-1040B is a chiplet. As used herein, a “chiplet” is a semiconductor die (or die) fabricated separately from other dies, and then interconnected with these other dies in a single integrated circuit in the multi-chip module (MCM). On a single silicon wafer, multiple chiplets can be fabricated as multiple instances of particular integrated circuitry. A first silicon wafer (or first wafer) is fabricated with multiple instances of integrated circuitry of a first chiplet, and this first wafer is diced using laser cutting techniques to separate the multiple copies of the first chiplet. A second silicon wafer (or second wafer) is fabricated with multiple instances of integrated circuitry of a second chiplet, and this second wafer is diced using laser cutting techniques to separate the multiple copies of the second chiplet.

In an implementation, each of the multiple compute circuits 1050A-1050N includes one or more vector processing circuits with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the multiple vector processing circuits, compute circuits 1050A-1050N also include an assigned number of vector general-purpose registers (VGPRs), an assigned number of scalar general-purpose registers (SGPRs), and an assigned data storage space of one or more of buffers 1060-1066. Schedulers in one or more of control circuit 110, processing elements 1040A-1040B and compute circuits 1050A-1050N receive instructions, such as instructions of stages, layers and nodes of a ML model, and determine when to execute the instructions.

Turning now to FIG. 11, a generalized diagram is shown of computational graphs 1100 of a machine learning model. As shown, computational graphs 1100 include computational graph 1110 and computational graph 1120 using four ML layers 1130, 1132, 1134 and 1136. The ML model receives input values (not shown) of a corresponding batch 1140 and generates the output values that include three tokens indicated as Token 0, Token 1 and Token 2. Although it is shown that the ML model includes four ML layers and generates three tokens, in other implementations, another number of ML layers and tokens are used based on design requirements. Each of computational graphs 1110 and 1120 provides a corresponding computational order for the ML layers 1130, 1132, 1134 and 1136. An example of a computation graph is computation graph 700 (of FIG. 7).

In an implementation, due to the available hardware resources and sizes of the ML layers 1130-1136 and corresponding parameters, a computing system loads the ML layers 1130-1136 one layer at time for execution by an accelerator circuit. For example, the memory subsystem is unable to support concurrently storing the parameters of multiple ML layers of ML layers 1130-1136 in the local memory of the accelerator circuit. Examples of the accelerator circuit are accelerator circuit 130 (of FIG. 1), accelerator circuit 952 (of FIG. 9), and parallel data processing circuit 1002 (of FIG. 10). Examples of the local memory are local memory 140 (of FIG. 1) and local memory 980 (of FIG. 9). Examples of the intermediate data being transferred between ML layers 1130-1136 are intermediate states, such as matrices 340, 350 and 360 (of FIG. 3), normalized attention scores 460 and context scores 470 (of FIG. 4), output vectors 560 (of FIG. 5), and output context vectors 660 (of FIG. 6).

The accelerator circuit loads weights corresponding to ML layer 1130, loads the instructions of the predefined modules (blocks and nodes) of ML layer 1130, and the accelerator circuit generates intermediate output values to be used by at least ML layer 1132. Afterward, using the row-by-row schedule (computational order) of computational graph 1110, the accelerator circuit offloads data, such as at least the weights of ML layer 1130, from local memory, loads weights corresponding to ML layer 1132 into local memory, loads the instructions of the predefined modules (blocks and nodes) of ML layer 1132, and generates intermediate output values to be used by at least ML layer 1134. These steps are repeated using the computational order shown by the row-by-row schedule (computational order) of computational graph 1110.

When using computational graph 1120, the accelerator circuit loads weights corresponding to ML layer 1130, loads the instructions of the predefined modules (blocks and nodes) of ML layer 1130, and the accelerator circuit generates intermediate output values to be used by at least ML layer 1132. In contrast to the row-by-row schedule (computational order) of computational graph 1110, the accelerator circuit does not immediately offload the weights of ML layer 1130 from local memory after generating the intermediate output values to be used by at least ML layer 1132. Rather, the accelerator circuit uses ML layer 1130 again using the same weights of ML layer 1130 for a set of input values corresponding to a second batch. By doing so, the computational graph 1120 follows a zig zag schedule (computational order) as shown. The accelerator circuit can repeat these steps using the weights of the ML layer 1130 for input values of N batches, where N is a positive, non-zero integer.

In some implementations, the value of N is set by the data storage capacity of local memory, which reduces as the accelerator circuit continues to generate intermediate data values when executing the instructions of ML layer 1130 repeatedly for new input values of new batches. Once the amount of available data storage of local memory is less than a data storage threshold or the count of batches having been processed reaches N, the accelerator circuit offloads data, such as at least the weights of ML layer 1130, from local memory, loads weights corresponding to ML layer 1132 into local memory, loads the instructions of the predefined modules (blocks and nodes) of ML layer 1132, and generates intermediate output values to be used by at least ML layer 1134. These steps are repeated using the computational order shown by the zig zag schedule (computational order) of computational graph 1120. In either case of using computational graph 1110 or 1120, when offloading data from local memory, the accelerator circuit uses the qualifying condition to determine whether to compress data before offloading the data from local memory. In various implementations, the accelerator circuit uses the sum and ratios to test the qualifying condition as described earlier regarding accelerator circuit 130 (of FIG. 1), method 800 (of FIG. 8), and accelerator circuit 952 (of FIG. 9).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
a control circuit configured to store, in a local memory of the apparatus, at least a first subset of weights of a plurality of subsets of weights;
a plurality of compute circuits configured to:
execute a first layer of a plurality of layers of a machine learning model using at least the first subset of weights as machine learning parameters; and
compress one or more of the first subset of weights and the intermediate data, responsive to:
completion of execution of the first layer; and
a compression ratio for data achievable by the plurality of compute circuits being greater than a ratio based on decompression throughput for data achievable by the plurality of compute circuits.

2. The apparatus as recited in claim 1, wherein the ratio comprises a sum divided by the decompression throughput, wherein the sum comprises the decompression throughput and a data transfer rate of a bus between the local memory and system memory.

3. The apparatus as recited in claim 1, wherein each layer of the plurality of layers processes data based on input data of a plurality of samples of a batch, wherein the machine learning model is a large language model that generates a corresponding token for each of the plurality of samples.

4. The apparatus as recited in claim 1, wherein the control circuit is configured to store, in system memory, the plurality of subsets of weights with one or more subsets comprising non-compressed weights and one or more subsets comprising compressed weights, wherein the compressed weights have redundant information removed from a non-compressed version and precision is maintained during later decompression.

5. The apparatus as recited in claim 1, wherein responsive to available data storage of the local memory being less than a storage threshold, the control circuit is configured to offload, from the local memory, one or more of the first subset of weights and machine learning intermediate data used as the machine learning parameters.

6. The apparatus as recited in claim 5, wherein the control circuit is configured to compress one or more of the first subset of weights and the machine learning intermediate data prior to offloading from the local memory to system memory, further responsive to a corresponding compression setting being enabled.

7. The apparatus as recited in claim 1, wherein as the apparatus retrieves a second subset of weights corresponding to a second layer of the plurality of layers, the control circuit is configured to offload, from the local memory, a non-compressed version of a third subset of weights corresponding to a third layer of the plurality of layers, in response to:
available data storage of the local memory being less than a storage threshold;
completion of execution of the third layer; and
the compression ratio being less than or equal to the ratio based on the decompression throughput.

8. A method, comprising:
storing, in a local memory of a processing circuit, at least a first subset of weights of a plurality of subsets of weights;
executing, by the processing circuit, a first layer of a plurality of layers of a machine learning model using at least the first subset of weights as machine learning parameters; and
compressing, by the processing circuit, the first subset of weights, responsive to:
completion of execution of the first layer; and
a compression ratio for data achievable by the plurality of compute circuits being greater than a ratio based on decompression throughput for data achievable by the plurality of compute circuits.

9. The method as recited in claim 8, wherein the ratio comprises a sum divided by the decompression throughput, wherein the sum comprises the decompression throughput and a data transfer rate of a bus between the local memory and system memory.

10. The method as recited in claim 8, further comprising processing, by the processing circuit, each layer of the plurality of layers based on input data of a plurality of samples of a batch, wherein the machine learning model is a large language model that generates a corresponding token for each of the plurality of samples.

11. The method as recited in claim 8, further comprising storing, in system memory by the processing circuit, the plurality of subsets of weights with one or more subsets comprising non-compressed weights and one or more subsets comprising compressed weights, wherein the compressed weights have redundant information removed from a non-compressed version and precision is maintained during later decompression.

12. The method as recited in claim 8, wherein responsive to available data storage of the local memory being less than a storage threshold, the method further comprises offloading, from the local memory by the processing circuit, one or more of the first subset of weights and machine learning intermediate data used as the machine learning parameters.

13. The method as recited in claim 12, further comprising compressing, by the processing circuit, one or more of the first subset of weights and the machine learning intermediate data prior to offloading from the local memory to system memory, further responsive to a corresponding compression setting being enabled.

14. The method as recited in claim 8, wherein as the processing circuit retrieves a second subset of weights corresponding to a second layer of the plurality of layers, the method further comprises offloading, from the local memory by the processing circuit, a non-compressed version of a third subset of weights corresponding to a third layer of the plurality of layers, in response to:
available data storage of the local memory being less than a storage threshold;
completion of execution of the third layer; and
the compression ratio being less than or equal to the ratio based on the decompression throughput.

15. A computing system comprising:
a system memory comprising circuitry configured to store at least a plurality of machine learning model weights partitioned into a plurality of subsets of weights; and
a processing circuit configured to execute a plurality of layers of a machine learning model in a computation order specified by a computational graph;
wherein the processing circuit comprises:
a plurality of compute circuits; and
a control circuit;
wherein the control circuit is configured to store, in a local memory of the processing circuit, at least a first subset of weights of the plurality of subsets of weights;
wherein the plurality of compute circuits is configured to:
execute a first layer of the plurality of layers of the machine learning model using at least the first subset of weights as machine learning parameters; and
compress one or more of the first subset of weights and the intermediate data, responsive to:
completion of execution of the first layer; and
a compression ratio for data achievable by the plurality of compute circuits being greater than a ratio based on decompression throughput for data achievable by the plurality of compute circuits.

16. The computing system as recited in claim 15, wherein the ratio comprises a sum divided by the decompression throughput, wherein the sum comprises the decompression throughput and a data transfer rate of a bus between the local memory and system memory.

17. The computing system as recited in claim 15, wherein each layer of the plurality of layers processes data based on input data of a plurality of samples of a batch, wherein the machine learning model is a large language model that generates a corresponding token for each of the plurality of samples.

18. The computing system as recited in claim 15, wherein the control circuit is configured to store, in system memory, the plurality of subsets of weights with one or more subsets comprising non-compressed weights and one or more subsets comprising compressed weights, wherein the compressed weights have redundant information removed from a non-compressed version and precision is maintained during later decompression.

19. The computing system as recited in claim 15, wherein responsive to available data storage of the local memory being less than a storage threshold, the control circuit is configured to offload, from the local memory, one or more of the first subset of weights and machine learning intermediate data used as the machine learning parameters.

20. The computing system as recited in claim 19, wherein the control circuit is configured to compress one or more of the first subset of weights and the machine learning intermediate data prior to offloading from the local memory to the system memory, further responsive to a corresponding compression setting being enabled.
